(19) United States
(12) Patent Application Publication
(10) Pub. No.: US 2011/0129715 A1
(43) Pub. Date: Jun. 2, 2011

(54) SECONDARY BATTERY

(75) Inventors: Jung-Yup Han, Yongin-Si (KR); No-Hyun Kwag, Yongin-Si (KR)

(73) Assignee: Samsung SDI Co., Ltd., Yongin-Si (KR)

(21) Appl. No.: 12/944,584

(22) Filed: Nov. 11, 2010

(30) Foreign Application Priority Data
Nov. 30, 2009 (KR) 10-2009-0117090

(51) Int. Cl. H01M 10/50

(52) U.S. Cl. 429/120

(57) ABSTRACT

A secondary battery including an electrode assembly having a first electrode, a second electrode, and a separator interposed between the first electrode and the second electrode; an electrode tab electrically connecting the electrode assembly to an external device; a case accommodating the electrode assembly therein and sealed so that the electrode tab is exposed outside of the case; and an uneven portion formed on a surface of the case in a direction parallel to a ground surface.

### CROSS-REFERENCE TO RELATED APPLICATIONS

This application claims the benefit of Korean Patent Application No. 10-2009-0117090, filed on Nov. 30, 2009, in the Korean Intellectual Property Office, the disclosure of which is incorporated herein by reference.

### BACKGROUND

1. Field

Aspects of the present invention relate to a secondary battery, and more particularly, to a case of a secondary battery.

2. Description of the Related Art

Secondary batteries are rechargeable batteries widely used in portable electronic devices, such as mobile phones, notebook computers, camcorders, and the like, and also in electric drive devices, such as electric bicycles, electric scooters, electric vehicles, and the like. A secondary battery includes a case having an open portion and an electrode assembly accommodated in the case through the open portion, and a cap plate covering the open portion. The electrode assembly includes a positive electrode, a negative electrode, and a separator, all of which are wound in a jelly-roll shape. Also, a current collecting plate is disposed on an end of the electrode assembly, and the current collecting plate is electrically connected to a terminal disposed in the cap plate. Thus, when the terminal of the cap plate is connected to an external terminal, a current generated in the electrode assembly is supplied to the external terminal via the current collecting plate and the terminal of the cap plate.

With recent increased interest in alternative energy, methods of using a secondary battery in electrically driven devices, such as electric bicycles and electric vehicles, have been developed. Electric bicycles include, in general, a frame, two wheels rotatably coupled with the frame, and tires coupled to the wheels. In addition, to rotate the two wheels, pedals are installed on opposite sides of the frame, and a driving force generated as the pedals rotate is transmitted to the wheels via a chain. A handle, which is directly controlled by a user, is installed on the frame to control a movement direction by adjusting an orientation of the wheels. In addition, a saddle providing a user with a seat is installed on the frame. In propelling bicycles, users rotate the pedal by using their feet so as to make the wheels rotate via the chain. Users control the handle simultaneously to adjust a direction of forward movement. However, when bicycles are moved via a manually rotated pedal, much energy is needed for moving a long distance or uphill. In particular, it is difficult for senior citizens to ride a bicycle for a long distance. Thus, a secondary battery capable of repeatedly performing charging and discharging may be used in a motor rotating wheels of a bicycle, and the motor driven by the secondary battery may help a user to ride a bicycle more easily.

### SUMMARY

Aspects of the present invention include a secondary battery including a case having an effective heat dissipating structure.

According to aspects of the present invention, a secondary battery includes an electrode assembly including a first electrode, a second electrode, and a separator interposed between the first electrode and the second electrode; an electrode tab electrically connecting the electrode assembly to an external device; and a case accommodating the electrode assembly therein and sealed so that the electrode tab is exposed outside of the case; and an uneven portion formed on a surface of the case in a direction parallel to a ground surface.

According to another aspect of the present invention, the uneven portion may be formed on an inside surface of the case. The uneven portion may be formed on an outside surface of the case. The uneven portion may be concave-shaped. The uneven portion may be formed on an inside surface of the case and on an outside surface of the case, and the uneven portion formed on the inside surface of the case and the uneven portion formed on the outside surface of the case may be alternately formed with respect to each other.

According to another aspect of the present invention, the uneven portion may be formed on an inside surface of the case and on an outside surface of the case, and the uneven portion formed on the inside surface of the case and the uneven portion formed on the outside surface of the case may be formed to correspond with respect to each other. The uneven portion may be formed on an inside surface of the case and on an outside surface of the case, and the uneven portion formed on the inside surface of the case may be formed in a direction parallel to the uneven portion formed on the outside surface the case. The uneven portion may be formed on an inside surface of the case and on an outside surface of the case, and the uneven portion formed on the inside surface of the case may be formed to cross the uneven portion formed on the outside surface of the case.

According to another aspect of the present invention, the case may be formed of aluminum.

According to another aspect of the present invention, the secondary battery may be used in an electric drive device. For example, the secondary battery may be used in an electric bicycle.

According to another aspect of the present invention, the secondary battery may be a lithium secondary battery.

In a secondary battery according to aspects of the present invention, assembling properties of a secondary battery do not deteriorate, and heat may be effectively released.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view of a secondary battery according to an embodiment of the present invention;

FIG. 2 is a schematic side view of an electric bicycle including the secondary battery of FIG. 1 attached thereto, according to an embodiment of the present invention;

FIG. 3 is a schematic view of a secondary battery, according to another embodiment of the present invention;

FIG. 4 is a schematic view of a secondary battery, according to another embodiment of the present invention;

FIG. 5 is a schematic view of a secondary battery, according to another embodiment of the present invention;

FIG. 6 is a schematic cross-sectional view taken along a line VI-VI′ of FIG. 1, according to an embodiment of the present invention;

FIG. 7 is a schematic cross-sectional view taken along the line VI-VI′ of FIG. 1, according to another embodiment of the present invention;

FIG. 8 is a schematic cross-sectional view taken along the line VI-VI′ of FIG. 1, according to another embodiment of the present invention; and

FIG. 9 is a schematic cross-sectional view taken along the line VI-VI′ of FIG. 1, according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

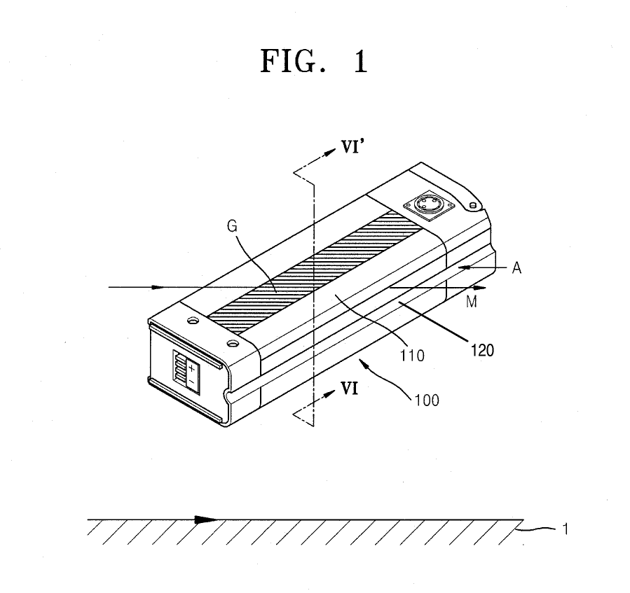

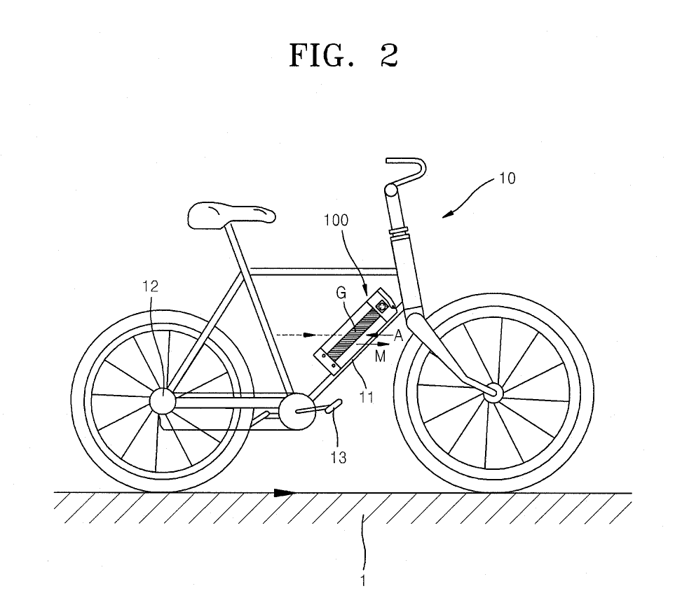

A secondary battery 100 and an uneven portion G formed on the secondary battery 100 will now be described with reference to FIGS. 1 and 2. FIG. 1 is a view of the secondary battery 100 according to an embodiment of the present invention. FIG. 2 is a schematic side view of an electric bicycle 10 including the secondary battery 100 of FIG. 1 attached thereto, according to an embodiment of the present invention. Referring to FIG. 1, the secondary battery 100 includes an electrode assembly (not shown), an electrode tab (not shown), and a case 110. The electrode assembly includes a cathode, an anode, and a separator between the anode and the cathode, all three of which are wound together. However, aspects of the present invention are not limited thereto, and the electrode assembly may have other configurations. The electrode tab is electrically connected to the electrode assembly. Thus, when the secondary battery 100 is connected to an external device (not shown) via the electrode tab, the secondary battery 100 is charged or discharged by electric power generated by the electrode assembly. The electrode assembly is accommodated in the case 110, and the case 110 is sealed so that the electrode tab connected to the electrode assembly is exposed out of the case 110. The secondary battery 100 is a lithium secondary battery. However, aspects of the present invention are not limited thereto, and the secondary battery may be other types of suitably batteries. For example, the secondary battery 100 may be any of various kinds of batteries including nickel-cadmium secondary batteries, nickel-hydrogen secondary batteries, and lithium batteries.

To efficiently dissipate heat generated by the electrode assembly during charging and discharging of the secondary battery 100 and to allow active heat exchange to occur, the case 110 is made of aluminum. However, aspects of the present invention are not limited thereto and the case 110 may be made of any of various materials capable of actively performing heat exchange by transferring heat generated in the secondary battery 100 to external air or an environment external to the case 110. In addition, a surface area of the case 110 may be increased to allow more heat exchange to actively occur between the case 110 and the external environment through conduction, convection, or radiation. To increase the surface area of the case 110, as illustrated in FIG. 1, the uneven portion G is formed on the surface of the case 110. The uneven portion G is also referred to as grooves G. According to the present embodiment, the uneven portion G is designed such that a surface of the case 110 has the grooves G therein. The uneven portion G can include a plurality of cooling grooves which may be formed in a direction that is different than the direction of a mounting groove 120 defined on the case 110. If the mounting groove is along a longitudinal direction of the case 110, then the cooling grooves can be considered to extend in a diagonal direction of the case 110. When the secondary battery 100 is mounted in an electric bicycle or electric car as an electric drive device, the uneven portion G may be formed in a direction parallel to a ground surface 1. Thus, the diagonal direction of the case 110 may be in a direction parallel to a ground surface 1. In certain situations, direction of movement of air at the cooling grooves may or may not be parallel to the ground surface 1 when the electric bicycle or car is in motion. For example, there may be a deflection of air flow due to some structure positioned relative to the case 110. Thus, a plurality of cooling features such as the cooling grooves can be formed on a surface of the case 110 so as to extend in a direction parallel to an expected direction of movement of air when the case is in motion. Aspects of the present invention are not limited thereto and the uneven portion G may have other shapes and designs that increase the surface are of the case 110 other than grooves.

With reference to FIG. 2, a reason for why heat exchange occurs more effectively in this case will now be described. Referring to FIG. 2, the secondary battery 100 is attached to an electric bicycle 10. When a user rides the electric bicycle 10 by using a pedal 13, the electric bicycle 10 moves forward in a bicycle movement direction M. In addition, the electric bicycle 10 is drivable by an auxiliary power source, such as a motor 12. The motor 12 is provided with electric power from the secondary battery 100. When the electric bicycle 10 moves along the bicycle movement direction M, the secondary battery 100 also moves in the bicycle movement direction M. Because of the movement of the secondary battery 100, air moves across a surface of the secondary battery 100 in a direction opposite to the bicycle movement direction M due to air resistance. An air movement direction A is opposite to the bicycle movement direction M, and the air movement direction A and the bicycle movement direction M are parallel to the ground surface 1. The grooves G are formed in the surface of the secondary battery 100 in a direction parallel to the air movement direction A, and thus air movement occurs along the grooves G. In this case, heat exchange actively occurs on the surface of the case 110 due to air migration. The electric bicycle 10 has a frame 11 having any of various structures suitable for a bicycle, and thus the grooves G formed in the surface of the secondary battery 100 are formed in a direction parallel to the ground surface 1.

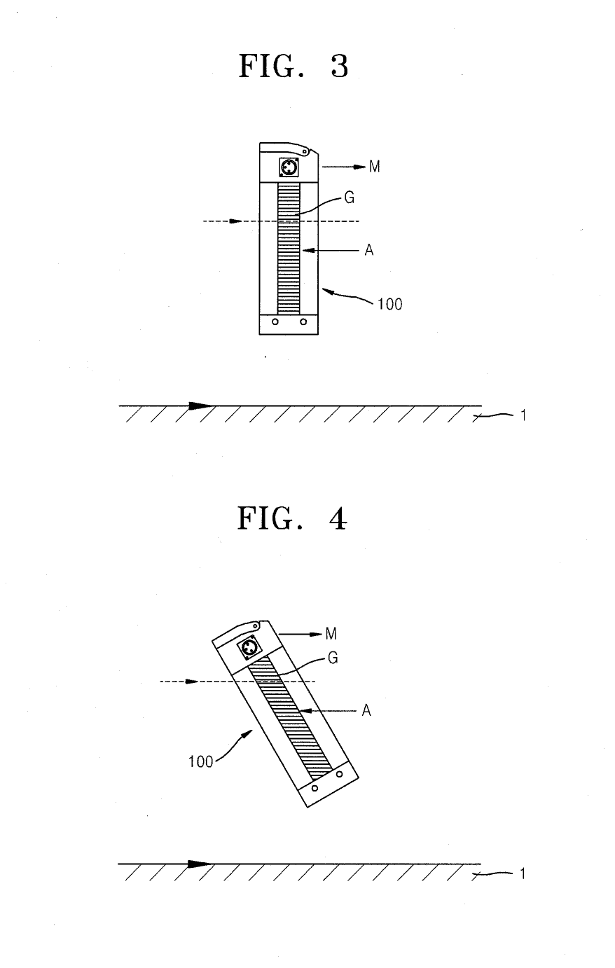

Examples of various structures of the secondary battery 100 will now be described with reference to FIGS. 3 and 4. FIG. 3 is a schematic concept view of a secondary battery 100, according to another embodiment of the present invention. FIG. 4 is a schematic concept view of a secondary battery 100, according to another embodiment of the present invention. Referring to FIGS. 3 and 4, according to a shape of the frame 11 (shown in FIG. 2) of the electric bicycle 10, the secondary battery 100 is disposed at various angles with respect to the ground surface 1. In this regard, each of the grooves G of the case 110 are formed in a direction parallel to the ground surface 1. In this case, when the electric bicycle 10 moves in the bicycle movement direction M, air movement occurs in the air movement direction A. Thus, corresponding to the air movement, the secondary battery 100 is actively cooled.

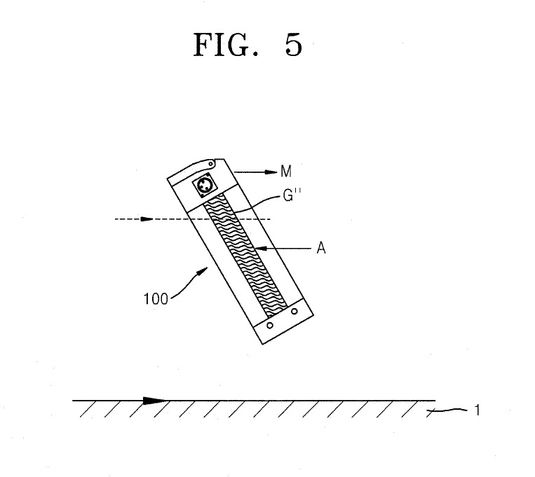

The expression “grooves G are formed in a direction parallel to the ground surface 1” used herein is understood to include that the grooves G may be formed in a direction that is not physically and completely parallel to the ground surface 1. For example, referring to FIG. 5, grooves G″ are formed in the surface of the case 110 in a wave shape, wherein an average line between peak and valley of the wave shape is parallel to the ground surface 1. In other words, a center line of the wave shape of the grooves G″ is parallel to the ground surface 1. In this regard, as the second battery 100 moves in the movement direction M, air moves across the grooves G″ in the air movement direction A, thereby facilitating cooling of the secondary battery 100. Thus, when the grooves G, G″ are recited as being in a direction parallel to the ground surface 1, or parallel to another surface, although the grooves of the embodiment of FIG. 5 are formed in a curved shape so as to allow air to move across the grooves G, G″, the imaginary line connecting midpoints between top and bottom points of the curved shape is substantially parallel to a surface to which the grooves G, G″ are recited as being parallel to.

According to the embodiments illustrated in FIGS. 1-9, the secondary battery 100 is used in the electric bicycle 10. However, aspects of the present invention are not limited thereto and the secondary battery 100 may be used in other devices. For example, the second battery 100 including the grooves G formed in a direction parallel to the ground surface 1 may be used in other electric drive devices, such as electric scooters or electric vehicles.

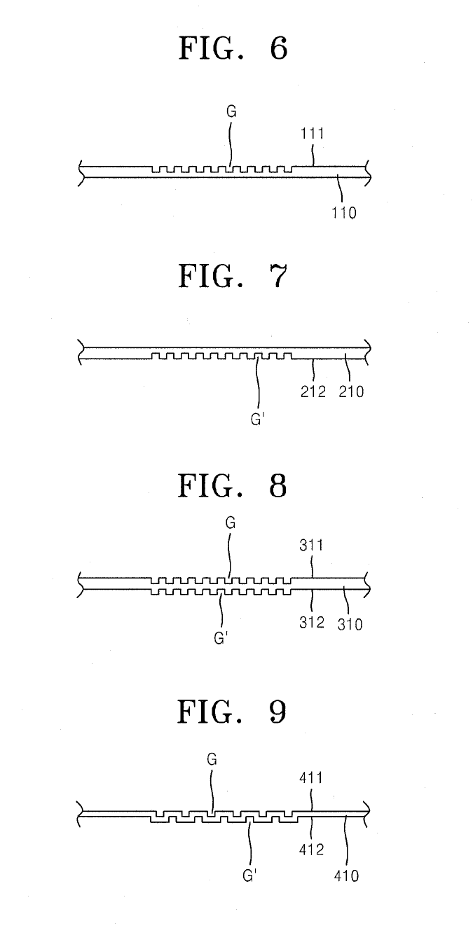

The shapes of the grooves G formed in a surface or surfaces of the case 110 will now be described with reference to FIGS. 6 through 9. FIG. 6 is a schematic cross-sectional view taken along a line VI-VI′ of FIG. 1, according to an embodiment of the present invention. FIG. 7 is a schematic cross-sectional view taken along the line VI-VI′ of FIG. 1, according to another embodiment of the present invention. FIG. 8 is a schematic cross-sectional view taken along the line VI-VI′ of FIG. 1, according to another embodiment of the present invention. FIG. 9 is a schematic cross-sectional view taken along the line VI-VI′ of FIG. 1, according to another embodiment of the present invention.

Referring to FIG. 6, the grooves G are formed in an external surface 111 of the case 110. In this regard, the grooves G are formed such that the external surface 111 of the case 110 has either a concave shape or convex shape. However, when the grooves G are convex-shaped, protruding portions are formed on the external surface 111. Thus, when the secondary battery 100 including such a structure is attached to the frame 11 of the electric bicycle 10, adhesion therebetween may deteriorate. In addition, if the grooves G are convex-shaped, when a user rotates the pedal 13, the user may be injured. Thus, for example, the grooves G are formed such that the external surface 111 of the case 110 has a concave shape.

Referring to FIG. 7, grooves G′ are formed in an internal surface 212 of a case 210.

The grooves G′ are formed such that the internal surface 212 has either a concave or a convex shape. However, the convex-shaped grooves G′ take up more space inside of the case 210 compared to the concave-shaped grooves G′.

Referring to FIG. 8, grooves G and grooves G′ are respectively formed in an external surface 311 and an internal surface 312 of a case 310. The grooves G formed in the external surface 311 of the case 310 and the grooves G′ formed in the internal surface 312 of the case 310 are alternately formed with respect to each other. However, aspects of the present invention are not limited thereto and the grooves G formed in the external surface 311 of the case 310 and the grooves G′ formed in the internal surface 312 of the case 310 may be formed to correspond to each other.

The grooves G formed in the external surface 311 of the case 310 are formed in a direction parallel to the ground surface 1, and the grooves G′ formed in the internal surface 312 of the case 310 are also be formed in a direction parallel to the ground surface 1 and corresponding to the grooves G. However, aspects of the present invention are not limited thereto and the direction of the grooves G′ may be formed to cross the grooves G. The expression “formed to cross” used herein means that the grooves G are formed in a direction parallel to the ground surface 1 and the grooves G′ are formed in a direction not parallel to the grooves G, for example, in a direction perpendicular to the grooves G or any other direction not parallel to the grooves G.

The grooves G and the grooves G′ are formed in an external surface 411 and an internal surface 412 of the case 410 in any of various forms. For example, referring to FIG. 9, the grooves G and G′ are formed by pressing the case 410 from both the external surface 411 and the internal surface 412. In this case, the surface area of the case 410 may be increased without deteriorating mechanical strength and stability of the case 410.

Furthermore, the secondary battery including the case having a structure of the embodiments described herein is usable in many device using a secondary battery.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery comprising:
an electrode assembly comprising:
a first electrode,
a second electrode, and
a separator interposed between the first electrode and the second electrode;
an electrode tab configured for electrically connecting the electrode assembly to an external device; and
a case having a mounting groove that extends along a first direction, the case configured for accommodating the electrode assembly therein and sealed so that the electrode tab is exposed outside of the case, the case defining a plurality of cooling grooves that extend along a second direction that is different than the first direction.

2. The secondary battery of claim 1, wherein the cooling grooves are formed on an inside surface of the case.

3. The secondary battery of claim 1, wherein the cooling grooves are formed on an outside surface of the case.

4. The secondary battery of claim 1, wherein each of the cooling grooves has a concave shape.

5. The secondary battery of claim 1, wherein the cooling grooves are formed on an inside surface of the case and on an outside surface of the case, and the cooling grooves formed on the inside surface of the case and the cooling grooves formed on the outside surface of the case are alternately formed with respect to each other.

6. The secondary battery of claim 1, wherein the cooling grooves are formed on an inside surface of the case and on an outside surface of the case, and the cooling grooves formed on the inside surface of the case and the cooling grooves formed on the outside surface of the case are formed to correspond with respect to each other.

7. The secondary battery of claim 1, wherein the cooling grooves are formed on an inside surface of the case and on an outside surface of the case, and the cooling grooves formed on the inside surface of the case are formed in a direction parallel to the cooling grooves formed on the outside surface of the case.

8. The secondary battery of claim 1, wherein the cooling grooves formed on an inside surface of the case and on an outside surface of the case, and the cooling grooves formed on the inside surface of the case are formed to cross the cooling grooves formed on the outside surface of the case.

9. The secondary battery of claim 1, wherein the case comprises aluminum.

10. The secondary battery of claim 1, wherein the secondary battery is used in an electric drive device and wherein the second direction of the cooling grooves is selected to be approximately parallel to a ground surface when the electric drive device and the secondary battery are in operation.

11. The secondary battery of claim 1, wherein the secondary battery is used in an electric bicycle and wherein the second direction of the cooling grooves is selected to be approximately parallel to a ground surface when the electric bicycle is in motion on the ground surface.

12. The secondary battery of claim 1, wherein the secondary battery is a lithium secondary battery.

13. The secondary battery of claim 1, wherein the plurality of cooling grooves define a plurality of parallel lines extending in the second direction.

14. The secondary battery of claim 13, wherein the plurality of parallel lines have a wave shape.

15. A secondary battery comprising:
an electrode assembly comprising:
a first electrode,
a second electrode, and
a separator interposed between the first electrode and the second electrode;
an electrode tab configured for electrically connecting the electrode assembly to an external device;
a case accommodating the electrode assembly therein and sealed so that the electrode tab is exposed outside of the case; and
a plurality of cooling features formed on a surface of the case and extending in a direction parallel to an expected direction of movement of air when the case is in motion.

16. The secondary battery of claim 15, wherein the direction of air movement is approximately parallel to an intended direction of case movement.
